(19) United States
(12) Patent Application Publication
(10) Pub. No.: US 2005/0273995 A1
(43) Pub. Date: Dec. 15, 2005

(54) Microfluidic device with electrode structures

(75) Inventors: Thirukumaran T. Kanagasabapathi, Calgary (CA); Karan V.I.S. Kaler, Bragg Creek (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: University Technologies International Inc., Calgary (CA)

(21) Appl. No.: 11/073,008

(22) Filed: Mar. 4, 2005

Related U.S. Application Data
(60) Provisional application No. 60/578,839, filed on Jun. 14, 2004.

(51) Int. Cl. G01N 27/27; H01S 4/00

(52) U.S. Cl. 29/592.1; 204/600

(57) ABSTRACT

The design, development and fabrication of a DEP microfluidic assembly with an in-built interdigitated microelectrode array is presented. Continuous fractionation of microparticles in a PDMS microfluidic channel is described. Experimental verification of positive and negative DEP of yeast cells and polystyrene latex beads is demonstrated. A microfluidic device with DEP arranged electrodes in a channel has posts extending into the channel for controlling shaping of DEP fields.

### CROSS-REFERENCE TO RELATED APPLICATIONS

This application claims the benefit under 35 USC 119(e) of provisional application 60/578,839 filed Jun. 14, 2004.

### BACKGROUND OF THE INVENTION

Development of miniaturized total analysis systems (μTAS) is of increasing interest among the research community. Often referred to as ‘Laboratory-on-a-chip’, this technology offers new prospects for routine chemical analysis, drug testing, bioassay, health care delivery, and diagnostic devices including non-invasive early detection of cancers. For over a decade, the realization of miniaturized laboratory functions onto a microchip capable of performing rapid chemical/biochemical analyses using very small inventories of samples and reagents has been a challenging goal for many leading research groups world wide. Successful implementation of such μTAS devices of chips requires the integration of expertise from various disciplines. With the use of technologies from the microelectronics process industry, fabrication of low cost microfluidic devices [1] has been made possible and conventional methods of fabricating microfluidic devices by etching glass or silicon are fast been replaced by soft lithography techniques [2,3]. Fabrication of microfluidic devices in Poly(dimethylsiloxane) [PDMS] is both rapid and cost effective compared to conventional methods [3,4,9]. References identified by numerals in square brackets are listed at the end of this patent document and are incorporated by reference herein.

The conventional approach for making PDMS microfluidic channels utilizes etched silicon wafers as the PDMS master. A layer of PDMS prepolymer is poured on the etched wafer and allowed to cure. The cured PDMS is then peeled from the substrate, oxygen plasma treated and bonded permanently to the glass substrate. PDMS microfluidic systems fabricated by this process are used more for the sample transport and cell culturing as a microduct than for any microparticle manipulation. PDMS is preferred and widely used material for microfluidic systems because of its elasticity, optical transparency, flexible surface chemistry, achievable channel fabrication precision, low permeability to water and low electrical conductivity.

### SUMMARY OF THE INVENTION

This patent document discloses methods of generating electric fields in microfluidic devices, particularly those fabricated with channels in PDMS (polydimethylsiloxane). In one example, electrodes are embedded into the microfluidic channel system. In another example, posts, for example made from PDMS, are incorporated into microfluidic channels to allow precise shaping of electric fields. Field-shaping metal electrodes embedded in the PDMS-glass hybrid microchannels may be used to manipulate and isolate microscopic particles including biological cells and biomaterials (DNA, RNA, Proteins). The technique of fabricating microchannels using PDMS may be combined with Dielectrophoresis (DEP) for manipulating microscopic particles including biological cells and in successful identification of their DEP ‘fingerprints’.

This technology expands upon basic PDMS technologies developed at the University of Calgary. Novel aspects of the invention include incorporating microelectrodes in PDMS microfluidic channels, forming a fluidic chip in a ‘Sandwich’ style of for example Glass+PDMS+Glass, forming an accurately controllable channel height and the fabrication process of this integrated microfluidic system.

In a further aspect of the invention, there is further disclosed a fabrication process for a microfluidic chip that uses posts for precise shaping of electric field patterns. Hollow PDMS posts filled with materials of different dielectric constant may be used for custom shaping the field pattern. Utilizing DEP in a microchannel intersection with posts permits synthesis of arbitrary fields and field shapes.

Further summary of the invention is found in the claims and detailed description that follows.

### BRIEF DESCRIPTION OF THE FIGURES

There will now be described preferred embodiments of the invention, by way of example, with reference to the figures, in which:

FIG. 1 shows a top view of an interdigitated electrode structure according to an embodiment of the invention;

FIG. 2 shows method steps A, B, C, a, b, c and D of a fabrication process sequence according to an aspect of the invention;

FIG. 3 is a perspective exploded view of an integrated microfluidic system according to an aspect of the invention with inbuilt planar electrodes;

FIG. 4 is a cross-section of the microfluidic system of FIG. 3;

FIG. 5 shows method steps A, B, C, D, E and F of a fabrication process sequence according to a further aspect of the invention;

FIG. 6 shows method steps A, B, C, D, E and F of a fabrication process sequence according to a still further aspect of the invention;

FIG. 7 is a perspective exploded view of a microfluidic system made with PDMS posts according to an aspect of the invention;

FIG. 8 is a close up view of a portion of FIG. 7;

FIG. 9 is a cross-sectional view of the portion of FIG. 7 shown in FIG. 8;

FIG. 10 is a top view of a microfluidic processing unit with a shallow horizontal channel for trapping cells at different heights of PDMS posts;

FIG. 11 shows method steps A, B, C, D, E and F of a fabrication process sequence for making PDMS posts;

FIG. 12 shows a field distribution due to posts of varying composition; and

FIG. 13 shows a cross-section of a post with a metallic filler, with the filler being biased towards the free end of the post.

### DETAILED DESCRIPTION OF PREFERRED EMBODIMENTS OF THE INVENTION

In this patent document, “comprising” is used in its inclusive sense and does not exclude other elements being present. In addition, the use of the indefinite article “a” before an element does not exclude others of that element being present. The electrodes referred to in this patent document are typically planar microelectrodes, where the term “micro” refers to features that are measured in microns, for example in the order of 10-200 microns.

Dielectric particles, such as intact biological cells, are electrically polarized when subjected to an alternating electric (A.C.) field. If this field is furthermore inhomogeneous, then the cells will experience a dielectrophoretic (DEP) force [5] that can act to convey them toward strong or weak field regions, depending on the dielectric polarization of the cell and that of the suspending medium [6,7,13].

The time averaged DEP force <\vec{F}_{DEP}> exerted by a non-uniform field of peak strength E acting on a homogenous spherical particle of radius a, immersed in a medium is given by [7]:
<\vec{F}_{DEP}>=2πεₘa³Re[Kₑ]∇Eᵣₘₛ²\vec{r} (1)
Where ∇Eᵣₘₛ² is the gradient of the square of the electric field.

The DEP force may attract (positive DEP) or repel (negative DEP) particles from the regions of higher field. The DEP force determined by the sign of Kₑ, the real part of complex Claussius-Mosotti factor, which is dependent on the complex permittivity of the particle and medium respectively [5,6].

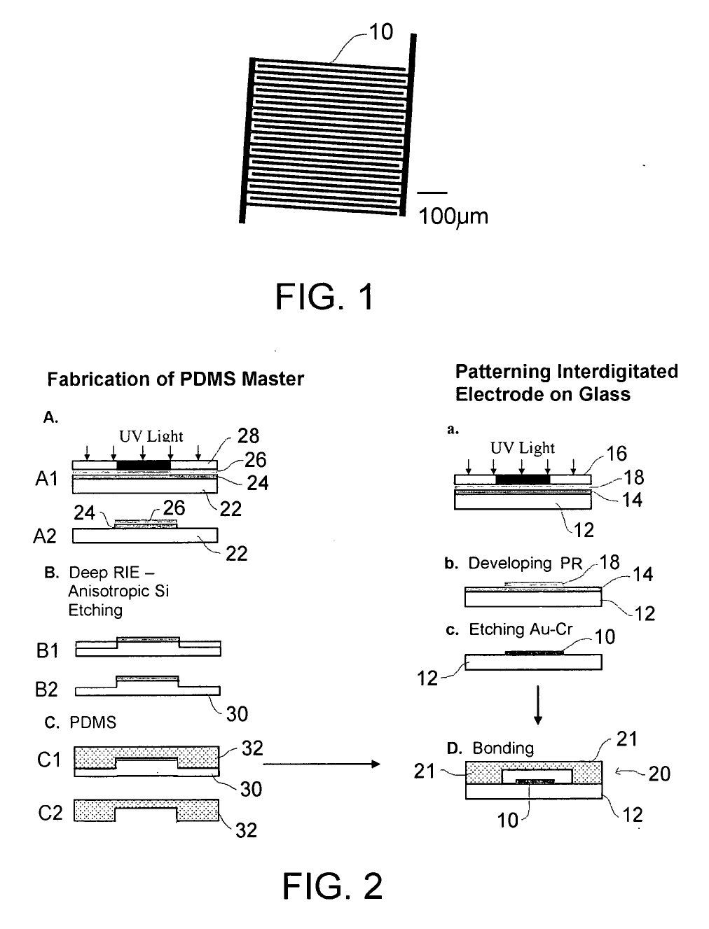

Poly(dimethylsiloxane) has been one of the most actively developed polymers for microfluidics, as it reduces the time, complexity and cost of prototyping and manufacturing [8]. Interdigitated electrodes 10 as shown in FIG. 1 are typically used to create the high field gradient necessary for DEP. The process of making the interdigitated electrodes 10 on a glass substrate 12 is shown in method steps a, b and c of FIG. 2, which involve patterning a chrome-gold film on an insulating glass substrate that forms the microelectrode array responsible for the synthesis of a periodic nonuniform electric field. In step a, a glass wafer 12 [such as Borofloat™ glass wafer available from Micralyne Inc., Edmonton] with a chrome-gold layer 14 of thickness 150 nm is coated with photoresist 18 such as HPR 504™ [Microchem Co.,] and soft baked at 110° C. for 30 min. After exposure to a 365 nm UV light source through a chrome mask 16 [for example ABM Mask Aligner], step b, the exposed wafer is developed [Dev-354™ Microchem Co.,]. The gold-chrome metallization layer in the exposed regions are etched by a wet chemical process in step c. The resulting electrode structure, an interdigitated example of which is shown in FIG. 1, where the width and the spacing between the successive electrode fingers is 20 μm. The electrodes may but need not be interdigitated. Many other geometric arrangements of such microelectrode are possible, limited only by the number of bonding pads and/or complexity of the interconnects.

FIG. 2, step D, shows a complete microfluidic device 20 embedded with an electrode array 10. The three walls 21 of the channels are formed in PDMS and the cover plate 12, necessary for an enclosed channel, is formed by the glass substrate housing the electrode array 10. To make the PDMS channel wafer, as shown in method step A1 of FIG. 2, a Si wafer 22 with a sacrificial oxide layer 24 of thickness 0.6 μm is coated with hexamethyldisiloxane (HMDS) at 150° C. and a layer of photoresist 26, HPR504™ [Microchem Co.] is spin coated on top and soft baked for 110° C. The wafer is then exposed to UV light through a chrome contact mask 28. The exposed areas are dissolved in Dev-354™ [Microchem Co.,] and the sacrificial oxide layer removed using Buffer oxide Etch as shown in step A2. Deep Reactive Ion Etching (DRIE) [Oxford Plasmalab-System100™] of the exposed Si wafer in step B to depth of for example 100 microns results in a re-usable master negative replica 30 of the desired channel with a vertical sidewall as shown in steps B1 and B2 of FIG. 2.

In step C of FIG. 2, a PDMS negative channel relief structure is made by molding PDMS onto the negative replica 30. PDMS prepolymer may be prepared by mixing two commercially available components [Sylgard 184™ Elastomer & Sylgard 184™ Curing Agent, Dow Corning]. The prepolymer may be mixed at 10:1 ratio by weight and subsequently poured onto the Si wafer and cured at 60° C. for 1 hr [3] as shown in step C1 of FIG. 2. The PDMS replica 32 is then peeled from the master as shown in step C2 of FIG. 2. Access holes for reservoirs can be made by placing posts on the masks or punched out of the cured layer.

PDMS is hydrophobic due to the presence of negatively charges silanol groups on the surface which results in the absorption of hydrophobic species and can easily nucleate air bubbles. Exposing the cured PDMS layer to oxygen plasma at a pressure of 0.15 torr renders the surface hydrophilic [3]. This process creates ozonation on the surface and enables an irreversible bonding of the PDMS to the glass substrate as shown in step D of FIG. 2. The glass substrate and the cured PDMS layer are exposed face-up to 80% oxygen plasma at a power of 45 watts for 90 secs. They are then sealed and placed on a hot plate at 60° C. for 45 secs. This forms a permanent seal, attempting to break the seal can result in the failure of the bulk PDMS. The seal can withstand pressures ranging from 30-50 psi [8,9].

A microfluidic device made in accordance with the method steps of FIG. 2 has been tested in the following experiments and polystyrene latex beads and yeast cells. Polystyrene latex beads 6 μm in diameter with carboxyl (COOH³¹) or plain surface (NH⁺) were purchased from Interfacial Dynamics (Interfacial Dynamics Corp., USA). The beads were washed and suspended in deionised water. Dilute samples were injected into the fluidic device using a microfluidic syringe pump [Cole-Parmer Co., Cambridge]. A 5ml plastic syringe provides a continuous flow in the range of 0.001 μI/h-14.33 ml/min [10]. Teflon tubing, tube end-fitting [Fisher Scientific Co.,] facilitates connection to the channel reservoir. Yeast cells (Saccharomyces Cerevisiae) were cultured for 2 days at 30° C. in a growth medium [1% yeast extract, 2% Glucose]. The samples are washed repeatedly with deionised water by centrifugation, the supernatant liquid decanted and the residual cells resuspended in fresh liquid. The final cells collected at the bottom after three successive centrifugations were diluted 1000-fold with deionised water prior to experimentation [11,12].

The dilute samples were injected into the microfluidic assembly as described and a function generator [Hewlett Packard, Model—33120A] was used to supply a sinusoidal voltage required for the electrode array. The DEP induced cell motion was observed utilizing a optical microscope (Olympus, BH2™)and the images captured by a video camera [Hitachi, VK-C350™] coupled to the microscope station.

Negative DEP of the polystyrene latex beads was observed when a voltage of 3.8 Vₚ₋ₚ of field frequency 480 kHz was applied to the chamber electrodes. The microbeads were observed to be levitated and formed ‘pearl-chains’ above the electrode. In contrast, yeast cells when subjected to a similar A.C voltage (3.7 Vₚ₋ₚ) at a field frequency of 580 kHz exhibited positive DEP and hence were attracted towards the region of maximum field intensity and collect at the electrode surface. A higher concentration of yeast cells collected near the electrode edges at regions of field maxima and formed ‘pearl-chains’.

A novel polymeric-glass microfluidic system with an integrated microelectrode array has been described. Fabrication of such low cost, reusable Microsystems capable of electro-manipulation of cells and experimental verification of positive and negative DEP has been demonstrated. The polystyrene beads levitated and confined above the electrode array were continuously removed by fluid flow. Thus, this non-invasive, easy to fabricate technique could be employed for the continuous fractionation of heterogeneous mixture of cells. Since PDMS can be molded at low temperatures without elaborate fabrication requirements, the microfluidic device can be readily fabricated in a normal laboratory setting. Further, integration of this technology with on-chip imaging, cell counting and control will provide a microsystem capable of quantitative and sensitive analysis of DEP signatures of various types of cancerous cells.

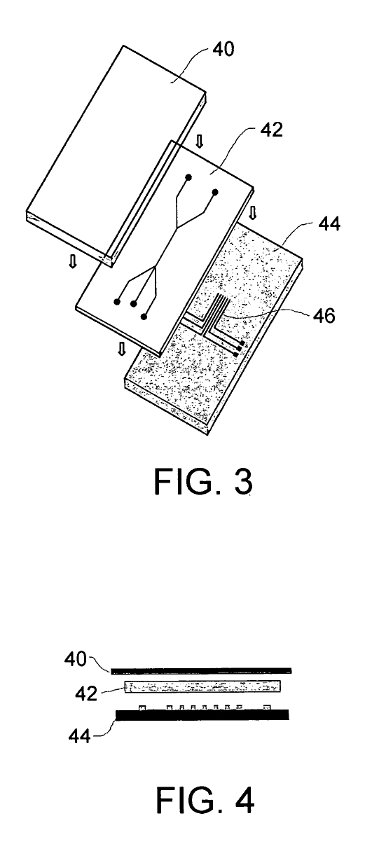

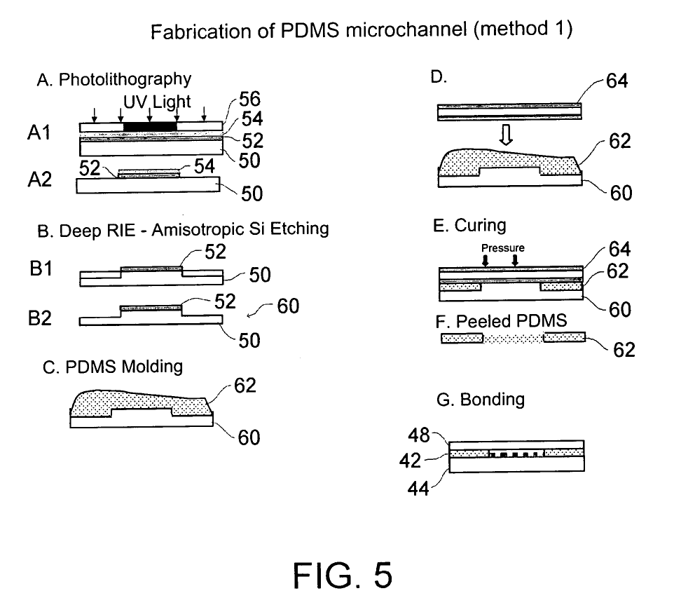

An embodiment of the invention with a glass top layer 40, PDMS middle layer 42 and glass bottom layer 44, with integrated microelectrodes 46 in the top and bottom layers will now be described in relation to FIGS. 3, 4, 5 and 6. A thin layer (150 nm) of Gold-Chrome metal or others metals is first deposited on the glass plate in accordance with the method steps a, b and c of FIG. 2. The deposited metal film is patterned into required electrode shape using conventional photolithographic technique. This aspect of the invention resides in integrating this patterned electrode on glass with PDMS polymer.

The open channels for fluids to pass over the electrodes are formed in PDMS layer 42. The height of the channel is determined by the thickness of PDMS layer 42. Glass plate 40 coated with a layer of transparent metal-oxide forms the top surface (roof) of the channel. This plate is grounded in an experimental setup, while the planar electrodes 46 generate electric fields. As described below, surface treatment of PDMS, handling of the thin, delicate PDMS layer, and reversible/Irreversible bonding of PDMS with Glass are all critical issues. Novel aspects of the microfluidic device reside in 3-tier layer of microfluidic system, integrating field-shaping electrodes to the PDMS microchannels, dielectrophoresis (DEP) in PDMS microchannels, open Channels in Poly(dimethylsiloxane), fabrication process and bonding technique, and using Hexamethyldisiloxane [HMDS] as releasing agent for peeling PDMS from Si-wafer.

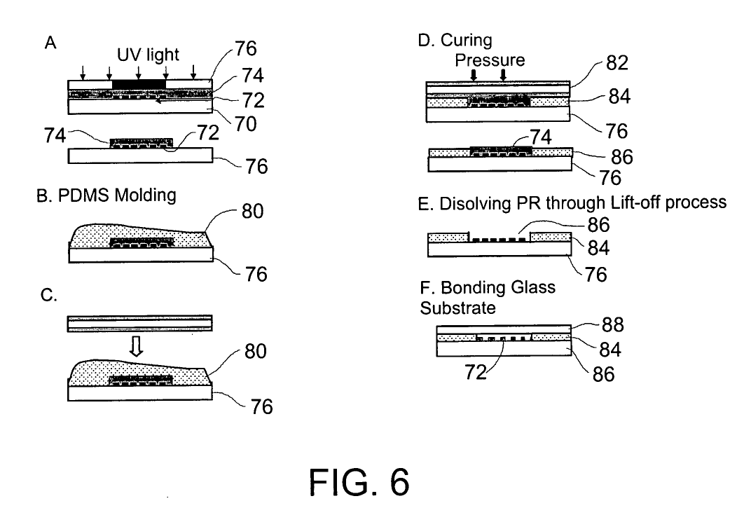

Two possible ways of fabricating the above structure are now described in relation to FIGS. 5 and 6. Extensive work has been done on the method of FIG. 5. The basic method steps shown in FIG. 5 are:

A. Patterning the sacrificial oxide layer on Si-wafer by standard photolithography technique

B. Exposed Oxide layer is removed by Buffer Oxide Etch

C. Deep Reactive ion etching of exposed Si-region results in vertical walled negative replica of the channel structure. This reusable wafer is used as PDMS master

D. Pouring PDMS prepolymer mixture

E. Multistack plate for applying uniform pressure on the prepolymer mix. The excess prepolymer above the channel structure is removed by applying uniform pressure above the stack.

F. Removing excess prepolymer, curing at 60° C. for 1 hr and peeling the resultant thin layer of PDMS

G. Bonding PDMS with glass (Patterning electrodes on bottom glass wafer is as discussed in FIG. 1.)

In the method schematized in FIG. 5, a Si wafer 50 with a sacrificial oxide layer 52 of thickness 0.6 μm is coated with hexamethyldisiloxane (HMDS) at 150° C. and a layer of photoresist 54, HPR504™ [Microchem Co.] was spin coated and soft baked at 110° C. on to the HMDS layer. The wafer 50 was then exposed to UV light through a chrome contact mask 56 in a photolithography step shown at A1 in FIG. 5. The exposed areas are dissolved in Dev-354198 [Microchem Co.,] and the sacrificial oxide layer removed using Buffer oxide Etch to yield the wafer shown at step A2. Deep Reactive Ion Etching (DRIE) [Oxford Plasmalab-System100™] of the exposed Si wafer at step B1 results in a negative replica 60 of the desired channel with a vertical sidewall as shown in step B2 of FIG. 5. The Si-wafer is then coated with a layer of hexamethyldisiloxane (HMDS), which assists in the release of PDMS.

The next step is a molding step. PDMS prepolymer 62 is prepared by mixing commercially available Sylgard 184™ Elastomer & Sylgard 184™ Curing Agent [Dow Coming Corp.]. The prepolymer 62 is mixed at 10:1 ratio by weight and subsequently poured onto the Si wafer 60 in step C. Excess PDMS is removed by applying uniform pressure on the poured prepolymer mixture using a multilayer stack 64 as shown in step D, and the stack is clamped and prepolymer cured at 60° C. for 1 hr as shown at step E to yield a PDMS channel replica 42. The PDMS replica 42 is then peeled from the master as shown in step F.

PDMS is hydrophobic due to the presence of negatively charged silanol groups on the surface which results in the absorption of hydrophobic species and can easily nucleate air bubbles. Exposing the cured PDMS layer 42 to oxygen plasma at a pressure of 0.15 torr renders the surface hydrophilic. This process creates ozonation on the surface and enables an irreversible bonding of the PDMS 42 to glass substrate 44 as shown at step G. The glass substrate 44 and the cured PDMS layer 42 are exposed face-up to 80% oxygen plasma at a power of 45 watts for 90 secs. They are then sealed and placed on a hot plate at 60° C. for 45 secs. This forms a permanent seal, attempting to break the seal can result in the failure of bulk PDMS.

The method of FIG. 5 yields a difficulty with aligning the PDMS channel with microelectrode and handling the thin PDMS layer is difficult. The following method can be used to overcome these issues.

In the method of FIG. 6, the following basic method steps are shown: Step A: Photoresist 74 with high aspect ratio features such as SU-8™ is used to form the negative replica of the channel is by spin coating onto a glass substrate 70 upon which is formed electrode structures 72 as shown in step A of FIG. 6. The device is patterned by conventional photolithography process to yield the glass bottom plate 76. PDMS prepolymer 80 is poured on the glass substrate 76 and allowed to cure as shown in step B of FIG. 6. During curing, a multilayer stack 82 is used for applying uniform pressure on the poured PDMS 80 as shown in step C. Excess PDMS is removed by clamping the stack 82 with the glass substrate 76 and the prepolymer 84 cured at 60° C. for 1 hr as shown in step D. In step E, the photoresist 74 is removed by a lift-off process yielding a PDMS layer 84 with open channel 86. As shown in step F, the PDMS layer 84 cured in glass substrate 76 is bonded with a top glass plate 88 containing metal oxide layer (not shown). This technique provides a simple solution to the alignment issues.

Concise electrical field shaping becomes critical in the successful implementation of Dielectrophoresis (DEP) for molecular manipulation. Active microfluidic chambers with specific field regions helps in isolating the cellular components selectively.

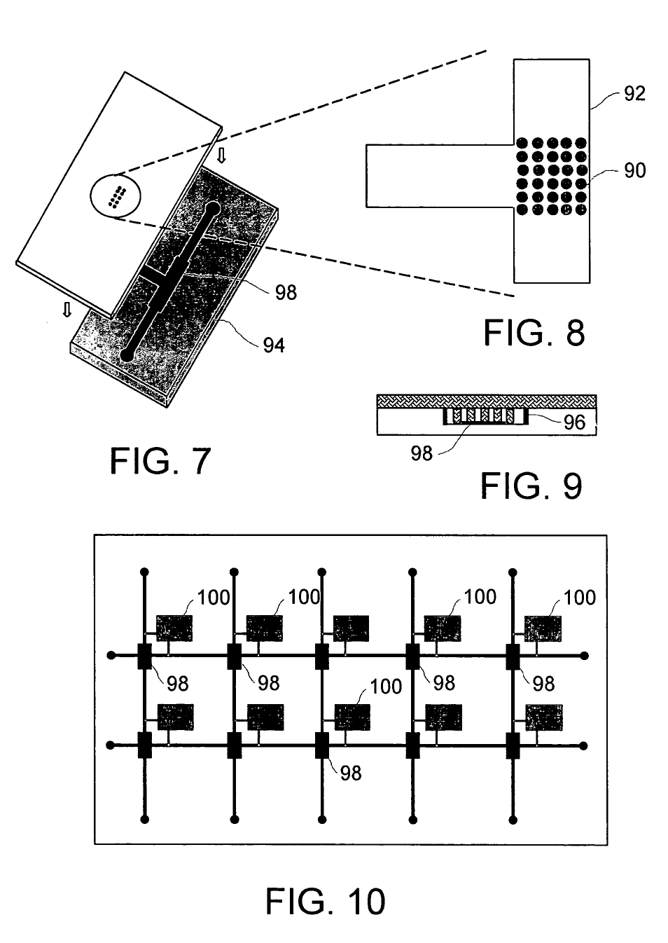

An embodiment of the invention is now described in relation to FIGS. 7, 8 and 9 in which PDMS is used to make posts 90 in a microfluidic channel-intersection 92 for shaping electric fields generated on a substrate 94 by electrodes 96 formed on the sides of a channel 98. PDMS is widely used for microfluidic systems because of its elasticity, optical transparency and flexible surface chemistry. In our approach, PDMS is used for making hollow posts and materials/liquids of different dielectric constants are used to fill the posts 90 and thereby in shaping specific field patterns. The electrodes 96 are patterned on the side walls or bottom surface of the glass channel 98 and the posts 90 are used in custom shaping of fields between them. This gives a three-dimensional control of field distribution in the active area and in forming very small active field traps for manipulating cellular components including DNA.

The height of a post 90 and its composition will be instrumental for specific field patterns. This unique method of refilling the posts with materials of different dielectric constant and varying composition serves to synthesize arbitrary fields of different field strength within the active area. The dimension of the post 90 helps in levitating cells at different height and levitated cells can then be transported into intersecting shallow channels.

This method of programming PDMS posts can be successfully utilized for developing multicomponent fluidic processing unit. This multicomponent analysis is carried in a controlled serial/parallel processing engine as shown in FIG. 10 in which multiple channel intersections with electrodes as in FIGS. 7, 8 and 9 are connected together in a grid, with the electrodes 96 being energized and controlled by control units 100.

Important features of the posts 90 include:

1. Field shaping posts where the introduction of metallic or dielectric media can be used to create/synthesize a variety of periodic and other arbitrary field geometries.

2. A large volume of the fluidic media is subjected to DEP force.

3. By suitable architecture of the unit cell configuration of FIG. 10, we can realize a more elaborate multi-sort/analysis system.

4. The communication between the processing blocks of FIG. 10 facilitates rapid and programmed sorting/analysis of molecular components.

5. The concept of a cell plug being processed in serial and parallel fashion provides a more detailed dielectric signature of heterogeneous population with the higher probability of identifying disease at the early stages when the cell deviations are very low.

6. These precise active regions can be utilized for the molecular and macromolecular assembly, trapping and manipulation. It serves as a step for lab-on-chip application utilizing DEP for manipulating biological components.

7. The integration of post and planar electrode both on the channel floor or ceiling allows another degree of freedom in field shaping. This when combined with multi depth channels will allow delivering of the sorted species to their respective target wells.

8. In addition to the posts, floor and ceiling electrodes, it may indeed be desirable to make use of sidewall conductor to shape fields outside the intersections.

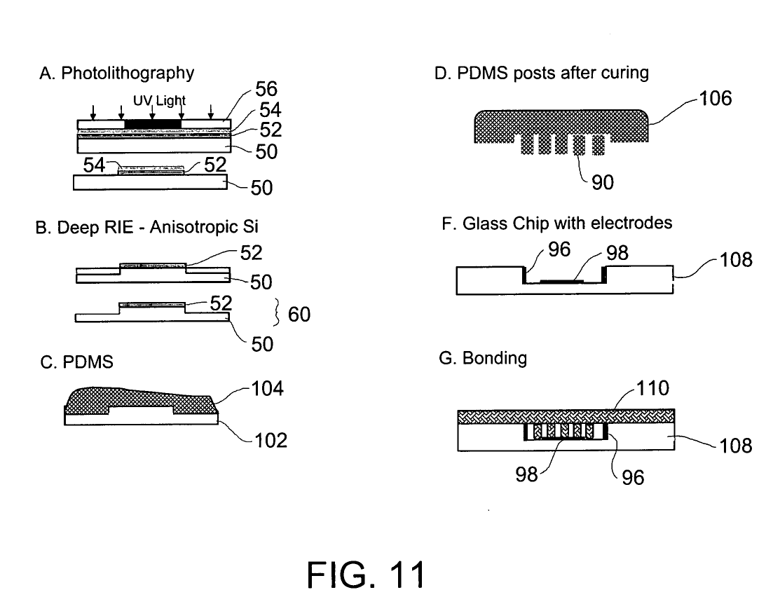

To make the posts, the method steps A and B of FIG. 5 are followed, as repeated in steps A and B of FIG. 11. In the method of FIG. 11, the Si-wafers 102 are used as negative replica in fabricating PDMS posts. The wafers 102 are etched by Deep-Reactive Ion Etching [14] of the exposed Si-region and results in vertical walled negative replica of the channel structure, with negative projection of required post dimension. The wafer 102 is re-usable as a PDMS master. A pre-polymer mix 104 is then poured at step C onto the wafer 102 and cured at specific temperature to yield the PDMS mold 106 with posts 90. Hexamethyldisiloxane (HMDS) is used as releasing agent. The cured PDMS 106 is peeled from Si-wafer 102 and bonded to a glass chip 108 containing an etched channel 98 and electrodes 96 embedded along its wall. A glass cover plate 110 is then bonded to the PDMS.

It will be understood that while particular examples of the fabrication methods and resulting structures are given, the examples given are exemplary embodiments of the invention. For example, while, in the method of microchannel fabrication, the step of “pouring PDMS prepolymer mixture” is given, this could be generally described as applying the PDMS prepolymer mixture to the wafer for example by spin-coat, spraying, pouring, molding techniques such as blow and injection molding, pressure driven flow of prepolymer on the negative master mold and other suitable means.

Also, in the exemplary method of channel fabrication in PDMS, the channel height is accurately controllable. In conventional methods of making molds, photoresists are spin coated on glass substrate to form the negative replica of the feature to be fabricated. Spin coating is not accurately controllable and the thickness varies in the range of 8 to 12 microns leading to an unreliable channel height. In the present approach, Si substrate is used to make the PDMS mold. The Si substrate is etched to form the negative replica of the desired pattern. It can be etched by Reactive Ion Etching, isotropic chemical etching and by other common etching processes like Cryo, Bosch and other similar process. These processes are accurately controllable in terms of etch rate and hence, molds of specific height can be fabricated repeatedly. Successful implementation of microfluidics to practical application is largely depending on the reliable channel dimensions. Spin coating of resists often results in an error rate of about 30-40% between successive experiments.

A particular novelty in the method of microchannel design is the integration of field shaping electrodes to the PDMS microchannels. In the proposed invention, thin films of metal deposited on insulating substrate are patterned to form electrodes of required shape. The electrodes are excited by non-uniform A.C. fields of suitable field frequency. This glass substrate with patterned metal electrodes forms the bottom surface of the PDMS system assembly. While most of the conventional PDMS applications were in cell culturing, PCR reaction chambers, chemical assays and other such applications, the proposed method of integrating metal electrodes to the microchannel assembly has not been reported till date.

Various possible uses for the method of channel fabrication may be made. The 3-tier architecture as proposed in the invention can be successfully used for manipulating pathogens, cells, DNA and other microparticles. Posts can be coated with a fluorophore material or other tagging agents such as molecular beacons and the pathogens can be attracted towards the post based on their affinity towards selective tagging agents. Optical transparency of PDMS helps in applications involving light sources up to 250 nm in wavelength. The reusable chips can be employed for other biological analysis process including capillary electrophoresis, etc.

A further novelty is the disclosure of use of HMDS in the fabrication process. Presence of silanol group in PDMS reacts with the Si substrate while curing and adheres firmly to the master mold. This affects the peeling process, cured polymer sticks to the mold and often results in bulk PDMS damage during peeling-off. Exposing etched Si substrate to a layer of Hexamethyldisiloxane (HMDS) has proven to help in easy peeling-off. HMDS acts as a releasing agent and further analysis of the reaction between PDMS-HMDS and Si substrate will reveal quantified process parameters for easy peeling-ff the polymer.

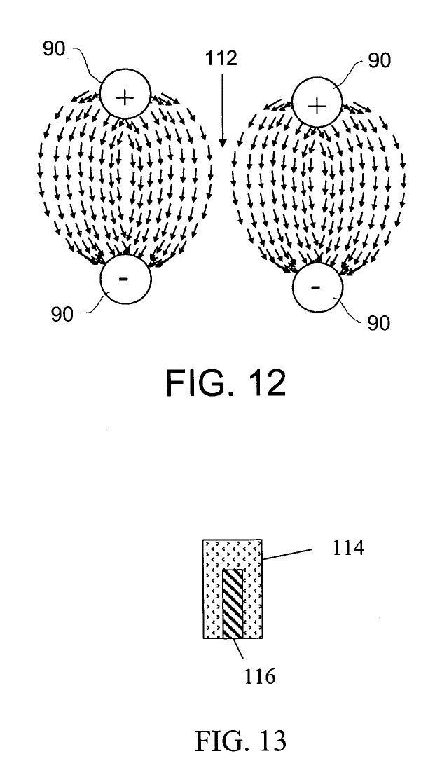

In an exemplary method of post fabrication, posts with varying magnetic properties may be made. Materials of different dielectric constant can be used to fill the posts during fabrication. Metals or other materials in the form of small pillars can be inserted into PDMS pre-polymer before curing. Molten state of pre-polymer holds the metal pillars in place when cured. A matrix of low and high field regions can be created by careful selection of materials to fill the post. For instance, insulating materials such as ceramics can fill the posts along the fluid flow between two conducting posts; this will help to streamline the flow of cells along the narrower field minima as shown in FIG. 12. The narrow stream of field minima 112 helps to form the pearl-chain of negatively repelled cells along the fluid flow. By varying the width of the field minima, cells can be sorted based on their size similar to coin sorter.

Various field shapes may be obtained by the posts. In FIG. 12, a field distribution is shown using posts 90 of varying composition. Field distribution is along line parallel to the fluid flow and hence cells that are negatively repelled will be streamlined along the central low field region and positive cells tend to get attached to the post. Field lines acting along the direction of fluid flow will result in streamlining cells along the channel length. Cells that are less polarizable than the media are concentrated towards the centre of flow and hence, streamlined towards output. The above representation of field flow can be reciprocated in the form of a matrix of successive positive and negative posts, for effective manipulation of micro and nano particles. Posts of insulating material can be placed in between the positive and negative posts 90, thereby creating an active nanofluidic channel within the fluidic system. The width of this active nanochannel is determined by the field intensity and can be used to trap nanoparticles including DNA. FIG. 13 shows a cross-section of a post 114 with a filler 116, which is here shown as metallic but could be any material suitable for shaping an electric field.

In the microfluidic devices disclosed here, a large volume of the fluidic media is subject to DEP force. With electrodes patterned on the channel surface, volume of fluid subjected to direct e-field was considerably smaller. Also, cells close to the surface of the channel were influenced by higher field intensity, while cells at higher level in the channel were influenced more by the particle-particle interaction than by the electric field by-itself. This may result in cells/particles subjected to different field intensity. In the proposed method, metal-PDMS post 90 occupies the whole height of the channel and hence, a larger volume of the sample is subjected to direct e-field than the previous methods. Cells/microparticles and cellular components can be trapped at various height in the active chamber based on their density and response to non-uniform field. This results in unique particle separation based on their combined density and dielectric polarization.

Serial and parallel processing of plugs may be made using posts 90, and a higher probability of disease detection is possible. In the proposed architecture as in FIG. 10, samples are manipulated at each intersection along the channel length. With varying post dimension and applied frequency, finer analysis of cells is made possible. Output of each experiment is fed to the successive active area for finer analysis. By increasing size of the post in each successive area, field minima region can be minimized and can be used for trapping DNA and other cellular components.

Simultaneously, cells can be processed in parallel across the two horizontal channels (upper and lower) in FIG. 10 under same or different experimental conditions. This helps in faster processing of samples and increased accuracy due to several processes running in parallel. Active areas are individually controllable and hence, precise control of each of this active area based on the particle to be manipulated is possible.

Several methods can be used for fabricating PDMS posts 90 described in this invention. Most prominent low cost process includes casting PDMS prepolymer on negative replica made using photoresist on glass, Si, plastics, metals or similar materials, etching Si/glass or other similar substrates by wet and dry chemical process, molding techniques such as injection and blow molding. Further, posts can be made by self-assembly of prepolymer mixtures. Fabrication may also involve incorporating carbon nanotubes made of specific metal atom to provide the necessary field manipulator.

Immaterial modifications may be made to the embodiments of the invention described by way of example here without departing from the invention.

### REFERENCES

[1] T. B. Jones et al, “Dielectrophoretic microfluidic devices,” Proc. of IEJ/ESA Joint Symposium on Electrostatics, 78-87, 2000.
[2] David C. Duffy, J. Cooper McDonald, Olivier J. A. Schueller and George M. Whitesides, “Rapid prototyping of Microfluidic Systems in Poly(dimethylsiloxane),” Anal. Chem., 70, 4974-4984, 1998.
[3] J. Cooper McDonald, David C. Duffy, Janella R. Anderson, Daniel T. Chiu, Hongkai Wu, Olivier J. A. Schuller and George M. Whitesides, “Fabrication of microfluidic systems in poly(dimethylsiloxane),” Electrophoresis, 27, 27-40, 2000.
[4] George M. Whitesides, Emanuele Ostuni, Shuichi Takayama, Xingyu Jiang, and Donald E. Ingber, “Soft Lithography in Biology and Biochemistry,” Annu. Rev. Biomed Eng., 3, 335-373, 2001.
[5] H. A Pohl, “Dielectrophoresis,” Cambridge University Press, New York, 1978.
[6] K. V. I. S Kaler and H. A. Pohl, “Dynamic Dielectrophoretic levitation of living cells,” IEEE Trans. Ind Apps., 1A-19, 1089-1093, 1983.
[7] Youlan Li and K. V. I. S. Kaler, “Dielectrophoretic fluidic cell fractionation system,” Analytica Chimica Acta, 507, 153-166, 2004.
[8] Younan Xia and George M. Whitesides, “Soft Lithography,” Annu. Rev. Mater. Sci., 28, 153-184, 1998.
[9] J. Cooper McDonald and George M. Whitesides, “PDMS as a material for fabricating microfluidic devices,” Accounts of Chemical Research, 35-7, 491-499, 2002.
[10] Li Cui, David Holmes and Hywel Morgan, “The dielectrophoretic levitation and separation of latex beads in microchips,” Electrophoresis,22, 3893-3901, 2001.
[11] W. M. Arnold, “Positioning, Levitation and Separation of Biological Cells,” Inst. Phys. Conf. Ser. No 163, 28-31, 1999.
[12] Peter R. C. Gascoyne and Jody Vykoukal, “Particle separation by Dielectrophoresis”, Electrophoresis, 23, 1973-1983, 2002.
[13] Ronald Pethig, Ying Haung, Xia-Bo Wang and Julian P H Burt, “Positive and negative dielectrophoretic collection of colloidal particles using interdigitated castellated micro-electrodes,” J. Phys. D: Appl. Phys., 25, 905-912, 1992.
[14] Ken-ichi Inatomi, Shin-ichi Izua, Sang-seok Lee, Hiroshi Ohji and Satoru Shiono, “Electrophoresis of DNA in micro-pillars fabricated in polydimethylsiloxane”, Microelectronic Engineering 70 (2003) 13-18.

1. A microfluidic device, comprising:
electrodes patterned on a surface of a substrate;
channel walls surrounding the electrodes and forming a channel, with the electrodes lying along at least one side of the channel; and
at least two of the walls being formed of polydimethylsiloxane.

2. The microfluidic device of claim 1 in which a top channel wall opposed to the electrodes comprises a top electrode, and polydimethylsiloxane walls form spacers between the top channel wall and the substrate.

3. The microfluidic device of claim 2 in which the top electrode is grounded, and each of the top channel wall and the substrate comprise glass.

4. The microfluidic device of claim 1 in which the channel walls comprise a top wall, and a pair of opposed side walls, each of the channel walls being formed of polydimethylsiloxane.

5. A method of making a microfluidic device, the method comprising the steps of:
creating a pattern of electrodes on a surface of a substrate;
bonding a channel shaped polydimethylsiloxane layer onto the substrate to define a channel between the channel shaped polydimethylsiloxane layer and the substrate, with the channel shaped polydimethylsiloxane layer forming at least two channel walls of the channel.

6. The method of claim 5 further comprising the step of:
creating the channel shaped polydimethylsiloxane layer by molding a polydimethylsiloxane prepolymer onto a channel master form, curing the polydimethylsiloxane prepolymer to form a channel shaped polydimethylsiloxane layer and removing the channel shaped polydimethylsiloxane layer from the channel master form.

7. The method of claim 6 in which the channel master form is coated with hexamethyldisiloxane as a release agent before molding of the polydimethylsiloxane prepolymer onto the channel master form.

8. The method of claim 6 further comprising the step of surface treating the channel shaped polydimethylsiloxane layer before bonding to the substrate to enable an irreversible bonding of the channel shaped polydimethylsiloxane layer to the substrate.

9. The method of claim 6 in which curing the polydimethylsiloxane prepolymer to form a channel shaped polydimethylsiloxane layer comprises the step of:
pressing a plate onto the polydimethylsiloxane prepolymer before curing to remove excess polydimethylsiloxane prepolymer.

10. The method of claim 9 in which the channel shaped polydimethylsiloxane layer forms opposing walls of the channel and the method further comprises the step of:
bonding a top layer onto the channel shaped polydimethylsiloxane layer to form a top channel wall.

11. The method of claim 10 further comprising integrating an electrode into the top channel wall.

12. The method of claim 5 further comprising the step of:
creating the channel shaped polydimethylsiloxane layer by molding a polydimethylsiloxane prepolymer onto a channel master form and curing the polydimethylsiloxane prepolymer to form a channel shaped polydimethylsiloxane layer.

13. The method of claim 12 in which the channel master form comprises a negative channel replica made of a removable material and curing the polydimethylsiloxane prepolymer to form a channel shaped polydimethylsiloxane layer comprises the steps of:
pressing a plate onto the polydimethylsiloxane prepolymer before curing to remove excess polydimethylsiloxane prepolymer; and
removing the removable material.

14. The method of claim 13 in which the removable material is a photoresist.

15. The method of claim 13 in which the channel shaped polydimethylsiloxane layer forms opposing walls of the channel and the method further comprises the step of:
bonding a top layer onto the channel shaped polydimethylsiloxane layer to form a top channel wall.

16. The method of claim 15 further comprising integrating an electrode into the top channel wall.

17. A microfluidic device, comprising:
electrodes patterned on a surface of a substrate;
channel walls surrounding the electrodes and forming a channel, with the electrodes lying along at least one side of the channel; and
posts extending from at least one channel wall into the channel.

18. The microfluidic device of claim 17 in which the posts extend from a top channel wall opposed to the electrodes.

19. The microfluidic device of claim 18 in which polydimethylsiloxane walls form spacers between the top channel wall and the substrate.

20. The microfluidic device of claim 18 in which the posts extend into an intersection of a pair of channels.

21. The microfluidic device of claim 20 further comprising a network of channels with multiple intersections, and posts extending into the channels at each of the multiple intersections.

22. The microfluidic device of claim 17 in which the channel walls comprise a top wall, and a pair of opposed side walls, each of the channel walls being formed of polydimethylsiloxane.

23. The microfluidic device of claim 17 in which the posts are hollow.

24. The microfluidic device of claim 17 in which the posts form at least two sets of posts with the posts of one of the two sets of posts having different field shaping characteristics from the posts of the other of the two sets of posts.

25. The microfluidic device of claim 17 in which electrodes lie along more than one side of the channel.

26. The microfluidic device of claim 17 in which the posts are coated tagging agents such as fluorophores or molecular beacons.

27. The microfluidic device of claim 17 in which the channel has a height and the posts extend the full height of the channel.

28. A method of making a microfluidic device, the method comprising the steps of:
creating a pattern of electrodes on a surface of a substrate;
creating a channel shaped polydimethylsiloxane layer with posts by molding a polydimethylsiloxane prepolymer onto a channel master form having a negative post replicas;
curing the polydimethylsiloxane prepolymer to form a channel shaped polydimethylsiloxane layer with posts;
removing the channel shaped polydimethylsiloxane layer from the channel master form; and
bonding the channel shaped polydimethylsiloxane layer onto the substrate, with the channel shaped polydimethylsiloxane layer forming a channel defined by channel walls surrounding the electrodes and the posts extending into the channel formed by the channel walls.
